(19) United States
(12) Patent Application Publication
(10) Pub. No.: US 2025/0168765 A1
(43) Pub. Date: May 22, 2025

(54) JOINTLY OPTIMIZE NETWORK AND DEVICE POWER SAVING

(71) Applicant: Lenovo (Singapore) Pte. Limited, Singapore (SG)

(72) Inventors: Tapisha Soni, Munich (DE); Karthikeyan Ganesan, Kronberg Im Taunus (DE); Ravi Kuchibhotla, Chicago, IL (US)

(73) Assignee: Lenovo (Singapore) Pte. Limited, Singapore (SG)

(21) Appl. No.: 18/951,346

(22) Filed: Nov. 18, 2024

Related U.S. Application Data
(60) Provisional application No. 63/600,710, filed on Nov. 19, 2023.

(51) Int. Cl. H04W 52/02; H04W 76/28

(52) U.S. Cl. CPC H04W 52/0206; H04W 76/28

(57) ABSTRACT

Various aspects of the present disclosure relate to jointly optimizing network and device power saving. An apparatus, such as a network equipment (NE), establishes an energy savings priority based on network energy savings and user equipment (UE) energy savings. The NE transmits a network energy saving (NES) configuration that is mapped to an NES class to a UE from which the UE establishes a (re) selection priority based at least in part on the network energy savings and the UE energy saving. The UE receives, from the NE as a cell, an indication of the NES configuration mapped to the NES class. The UE determines a remaining active time of the cell based on the NES configuration, and evaluates one or more cell-sleep conditions based on a UE cell-active threshold, a UE cell-sleep threshold, and a UE power saving state supported by the cell.

### RELATED APPLICATION

This application claims priority to U.S. Provisional Application Ser. No. 63/600,710 filed Nov. 19, 2023 entitled “Jointly Optimize Network and Device Power Saving,” the disclosure of which is incorporated by reference herein in its entirety.

### TECHNICAL FIELD

The present disclosure relates to wireless communications, and more specifically to network energy saving (NES) and device power saving.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, emissions and energy consumption from different elements of the system adversely contribute to the climate, and the operating expenses to run telecommunication services are immense. The increasing use of mobile data traffic will only continue to increase, combined with the rising costs of spectrum, capital investment, and ongoing RAN maintenance and upgrades, energy-saving measures in network operations are needed.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive an indication of one or more of an NES configuration or an NES class. The UE determines a remaining active time of a cell based at least in part on the NES configuration. The UE evaluates one or more cell-sleep conditions based at least in part on a UE cell-active threshold, a UE cell-sleep threshold, and a UE power saving state supported by the cell.

In some implementations of the method and apparatuses described herein, the UE determines whether the one or more cell-sleep conditions include the remaining active time of the cell is greater than the UE cell-active threshold; and an off-time period of the cell is greater than the UE cell-sleep threshold. The off-time period of the cell is a discontinuous transmission and discontinuous reception (DTX/DRX) off-time of the cell. The UE prioritizes the cell for (re) selection if the one or more cell-sleep conditions are met. The UE down-prioritizes the cell for (re) selection if the one or more cell-sleep conditions are not met. The UE receives a DTX/DRX configuration from the cell; and determines the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The UE performs cell (re) selection based at least in part on the NES configuration and the UE power saving state. The UE prioritizes the cell for (re) selection based first on the UE power saving state and subsequently based on the one or more cell-sleep conditions. The UE prioritizes the cell for (re) selection based first on the one or more cell-sleep conditions and subsequently based on the UE power saving state.

Some implementations of the method and apparatuses described herein may further include a processor for wireless communication to receive an indication of one or more of an NES configuration or an NES class. The processor determines a remaining active time of a cell based at least in part on the NES configuration. The processor evaluates one or more cell-sleep conditions based at least in part on a UE cell-active threshold, a UE cell-sleep threshold, and a UE power saving state supported by the cell.

In some implementations of the method and apparatuses described herein, the processor determines whether the one or more cell-sleep conditions include the remaining active time of the cell is greater than the UE cell-active threshold; and an off-time period of the cell is greater than the UE cell-sleep threshold. The off-time period of the cell is a DTX/DRX off-time of the cell. The processor prioritizes the cell for (re) selection if the one or more cell-sleep conditions are met. The processor down-prioritizes the cell for (re) selection if the one or more cell-sleep conditions are not met. The processor receives a DTX/DRX configuration from the cell; and determines the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The processor performs cell (re) selection based at least in part on the NES configuration and the UE power saving state. The processors prioritizes the cell for (re) selection based first on the UE power saving state and subsequently based on the one or more cell-sleep conditions. The processor prioritizes the cell for (re) selection based first on the one or more cell-sleep conditions and subsequently based on the UE power saving state.

Some implementations of the method and apparatuses described herein may further include a method performed by a UE, the method including receiving an indication of one or more of an NES configuration or an NES class; determining a remaining active time of a cell based at least in part on the NES configuration; and evaluating one or more cell-sleep conditions based at least in part on a UE cell-active threshold, a UE cell-sleep threshold, and a UE power saving state supported by the cell.

In some implementations of the method and apparatuses described herein, the method further comprising determining whether the one or more cell-sleep conditions include the remaining active time of the cell is greater than the UE cell-active threshold; and an off-time period of the cell is greater than the UE cell-sleep threshold. The off-time period of the cell is a DTX/DRX off-time of the cell. The method further comprising prioritizing the cell for (re) selection if the one or more cell-sleep conditions are met. The method further comprising down-prioritizing the cell for (re) selection if the one or more cell-sleep conditions are not met. The further comprising receiving a DTX/DRX configuration from the cell; and determining the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The method further comprising performing cell (re) selection based at least in part on the NES configuration and the UE power saving state. The method further comprising prioritizing the cell for (re) selection based first on the UE power saving state and subsequently based on the one or more cell-sleep conditions. The method further comprising prioritizing the cell for (re) selection based first on the one or more cell-sleep conditions and subsequently based on the UE power saving state.

Some implementations of the method and apparatuses described herein may further include an NE for wireless communication to establish an energy savings priority based on at least network energy savings and UE energy savings. The NE transmits an NES configuration that is mapped to an NES class to a UE from which the UE establishes a (re) selection priority based at least in part on the network energy savings and the UE energy saving.

In some implementations of the method and apparatuses described herein, the NES configuration indicates the (re) selection priority based first on the UE energy savings and subsequently based on the network energy savings. The NES configuration indicates the (re) selection priority based first on the network energy savings and subsequently based on the UE energy savings.

Some implementations of the method and apparatuses described herein may further include a method performed by an NE, the method including: establishing an energy savings priority based on at least network energy savings and UE energy savings; and transmitting an NES configuration that is mapped to an NES class to a UE from which the UE establishes a (re) selection priority based at least in part on the network energy savings and the UE energy saving.

In some implementations of the method and apparatuses described herein, the NES configuration indicates the (re) selection priority based first on the UE energy savings and subsequently based on the network energy savings. The NES configuration indicates the (re) selection priority based first on the network energy savings and subsequently based on the UE energy savings.

### BRIEF DESCRIPTION OF THE DRAWINGS

FIG. 1 illustrates an example of a wireless communications system in accordance with aspects of the present disclosure.

FIG. 2 illustrates an example procedure for prioritization or down-prioritization of a cell for an RRC idle UE, in accordance with aspects of the present disclosure.

FIGS. 3, 4 illustrate examples of cell-sleep conditions, in accordance with aspects of the present disclosure.

FIG. 5 illustrates another example procedure for prioritization or down-prioritization of a cell for an RRC idle UE, in accordance with aspects of the present disclosure.

FIGS. 6, 7 illustrate examples of cell selection prioritization, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by a NE in accordance with aspects of the present disclosure.

### DETAILED DESCRIPTION

A wireless communications system includes a great many number of components, devices, services, and equipment, many of which contribute to rising network costs and operational expenses. Additionally, the emissions and energy consumption from the many different network elements adversely contribute to the climate. The increasing use of mobile data traffic will only continue to increase, combined with the rising costs of spectrum, capital investment, and ongoing RAN maintenance and upgrades, energy-saving measures in network operations are needed. In particular, new communications use cases and the adoption of mm-Wave will require more sites and antennas. Although this lends to the prospect of a more efficient network, the result will be an increase in emissions without active intervention. As 5G becomes pervasive across industries and geographical areas, handling more advanced services and applications requiring very high data rates, networks are becoming denser, using more antennas, larger bandwidths, and more frequency bands. Implementations of NES can help to control the environmental impact of expanding 5G.

In a wireless communications system, most of the energy consumption is due to the radio access network and in particular, from the active antenna unit (AAU), with data centers and fiber transport accounting for a smaller share of the energy consumption. The power consumption of radio access can be split into two parts, a dynamic part that only consumes power when data transmission and/or reception is ongoing, and a static part during which power is consumed all of the time to maintain the necessary operation of the radio access devices, even when the data transmission and/or reception is not on-going. Power savings techniques are therefore needed, particularly with reference to base stations, for NES and to achieve more efficient operation dynamically and/or semi-statically, with a finer granularity adaptation of transmissions and/or receptions in one or more network energy saving techniques in time, frequency, spatial, and power domains, as well as support and feedback from UEs, potential UE assistance information, and an information exchange and coordination over network interfaces. Any potential network energy consumption gains also need to take into account the impact on network and UE performance by looking at key performance indicators (KPIs) such as spectral efficiency, capacity, user perceived throughput (UPT), latency, UE power consumption, complexity, handover performance, call drop rate, initial access performance, service level agreement (SLA) assurance related KPIs, etc.

Standardized NES capability can improve energy savings, as well as importantly serve the UEs without compromising performance. The diverse use cases from industry verticals lead to different traffic models and service quality of service (QOS). It may be essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur, such as for example, a cell benefiting from maximum energy saving cannot satisfy latency-critical service requirements of sub-millisecond end-to-end latency for multiple UEs. Such degradation in QoS is intolerable for use cases like augmented reality and/or virtual reality (AR/VR), haptic feedback, autonomous vehicles, mission-critical communication, mobile robots, etc. Hence, an adaptive and robust NES mechanism is implemented to attain an optimal balance.

Conventionally, RRC idle and RRC inactive UEs are unaware of the network and device power saving features supported by the network. The cell selection or reselection procedure is performed irrespective of the NES mode configured and the UE power saving feature supported in a cell. An idle UE lacks the flexibility to pursue a cell that can eventually increase its connectivity time in the cell and fulfill service requirements. This can lead to user performance degradation and thus service interruption. The NES mode is limited to RRC connected UEs, however, it is essential to consider the effect of energy savings on the UE in the RRC idle mode. When in the RRC idle mode, a UE performs cell selection or reselection without any knowledge of the energy saving mode configured or activated in the respective candidate cells, and does not t take into account the UE capability. This can lead to UEs connecting to cells configured with energy saving solutions and experiencing performance degradation unacceptable for stringent service categories. Otherwise, a UE may connect to the cells where the device power saving mode is not supported.

Aspects of the disclosure are directed to jointly optimize network energy saving and device power saving, which in turn, facilitates the tradeoff in energy savings and user performance. A cell selection or reselection approach is proposed, which assists an RRC idle UE to classify the candidate cells based on the configured NES mode (e.g., DTX/DRX configuration) and the UE power saving feature supported by the cell. Further, this solves the problem of unfavorable cell selection or reselection for an RRC idle UE due to the NES mode configured in the cell. Further, aspects of the disclosure are directed to ensuring user performance while efficient network energy saving as well as UE power saving is achieved. Techniques include enhancements to the existing cell (re) selection for a UE in RRC idle mode, to enable the UE to perform cell (re) selection while considering the energy saving mode configured in the cell, as well as the UE power saving features supported by the cell. This includes new UE thresholds defining tolerable cell active time and cell sleep time, as well as new cell (re) selection evaluation conditions based on the NES configuration and supported UE power saving feature in the cell. These cell access conditions for an NES-capable UE enable prioritization or down-prioritization of NES cells, and allows for further granularity for barring UEs from NES cells for a balanced energy saving and user performance.

In aspects of this disclosure, new UE thresholds define a tolerable cell active time and cell sleep time. Additionally, supplementary cell (re) selection evaluation conditions are introduced to assist the UE in Idle mode. The cell (re) selection criteria can be applied jointly to both network and device power saving, or based on the assigned priority. Thus, it allows flexibility to handle the network and device power saving jointly. The described solutions extend the energy saving mode to RRC idle UEs, otherwise, an RRC idle UE might connect to any NES cell without being aware of its NES capability leading to radio link failure or performance degradation. The UE may not consider any cell (re) selection evaluation criteria related to the NES or device power saving, which therefore may lead to a UE connecting to a non-favorable cell, either with an NES mode that doesn't fulfill its service requirements, or to a cell that does not support UE power saving. The described techniques provided a mechanism to ensure user performance while efficient network energy saving and UE power saving is achieved using the NES class. An enhancement to the existing cell (re) selection can be implemented, which assists an RRC idle UE to classify the candidate cells based on the configured NES mode (e.g., DTX/DRX configuration) and the UE power saving feature supported by the cell. The UE behavior in the idle mode for evaluating cell (re) selection is defined, for different use cases, such as UE power saving as a priority, user performance from NES as a priority, or both as priority. This approach jointly optimizes the network energy saving and device power savings.

Aspects of the present disclosure are described in the context of a wireless communications system to jointly optimize network and device power savings.

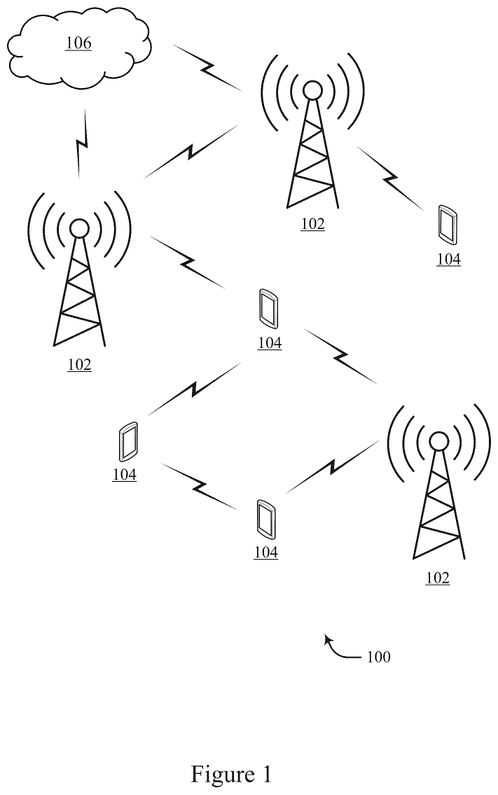

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station, gNB) establishes an energy savings priority based on network energy savings and UE energy savings. The NE 102 transmits an NES configuration that is mapped to an NES class to a UE 104 from which the UE establishes a (re) selection priority based on the network energy savings and the UE energy saving. The UE 104 receives, from the NE as a cell, an indication of one or more of the NES configuration or the NES class. The UE 104 determines a remaining active time of the cell based on the NES configuration, and evaluates one or more cell-sleep conditions based on a UE cell-active threshold, a UE cell-sleep threshold, and a UE power saving state supported by the cell.

A technique to improve network energy savings in time domain is cell DTX/DRX, which is applicable to UEs in a RRC connected state. A periodic cell DTX/DRX (i.e., active, and non-active periods) can be configured by gNB via UE-specific RRC signaling per serving cell, and cell DTX/DRX can also be configured and operated together. At least the following parameters can be configured per cell DTX/DRX configuration, including periodicity, start slot/offset, and on duration. UE behavior is a focus when, at any point in time, the cell activates a single DTX/DRX configuration. It is up to network whether legacy UEs in an idle mode can access cells with cell DTX/DRX and the network should be able to allow NES-capable UEs to camp on the NES cell. The cell DTX/DRX mode can be activated or deactivated via dynamic L1/L2 signaling and UE-specific RRC signaling. Both UE specific and common L1/L2 signaling can be considered for activating and deactivating the cell DTX/DRX mode. As considered, the network can configure NES capable UEs to (de) prioritize NES cells, with a mechanism such as can be considered for both frequency and cell levels cell selection or reselection (de) prioritization. Separate camping restrictions for NES-capable and non-NES UEs can also be defined.

The main motivation behind standardizing NES capability is to improve the energy savings as well as to serve the users without compromising performance. The diverse use cases from industry verticals lead to different traffic models and service QoS. It is essential to conserve maximum network energy while fulfilling the stringent QoS requirements of these diverse service categories. Additionally, the traffic pattern can be expected to change with the type of use case and/or network scenario. Therefore, a tradeoff in energy savings and the demanded KPIs is likely to occur (e.g., a cell benefiting from maximum energy saving cannot satisfy latency-critical service requirements of sub-millisecond end-to-end latency for multiple UEs). Such degradation in QoS is intolerable for use cases like AR/VR, haptic feedback, autonomous vehicles, mission-critical communication, mobile robots, etc. Hence, an adaptive and robust NES mechanism is crucial to attain an optimal balance.

With reference to jointly optimize network and device power savings, as described herein, the NES mode is limited to RRC connected UEs, however, it is essential to consider the effect of energy savings on the UE in RRC idle mode. When in RRC idle mode, a UE performs cell selection or reselection without any knowledge of the energy saving mode configured or activated in the respective candidate cells, and does it take into account the UE capability for power saving in the idle mode. This can lead to UEs connecting to cells configured with energy saving solutions and experiencing performance degradation unacceptable for stringent service categories. Otherwise, UEs may connect to the cells where the device power saving mode is not supported.

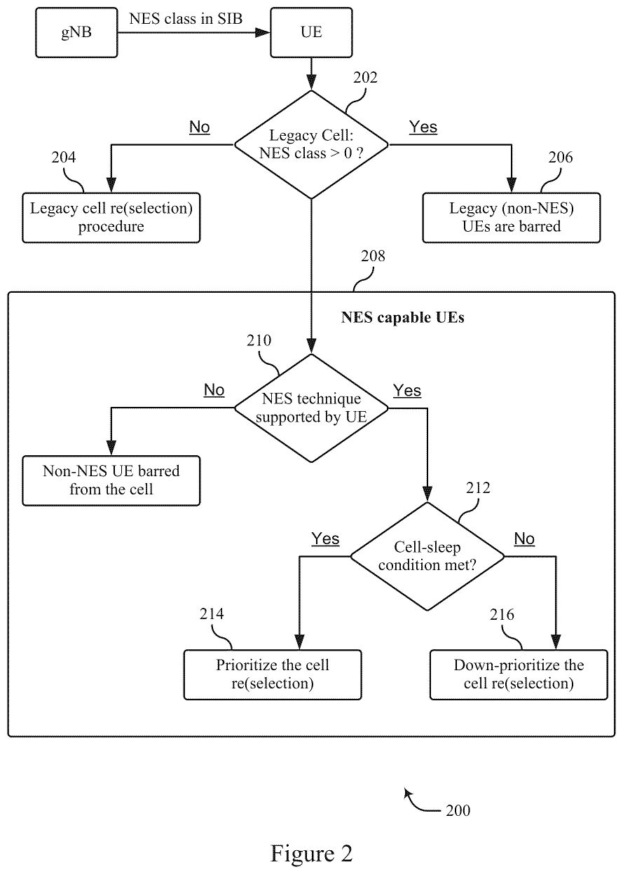

To circumvent unwanted radio link failure and to ease the process of cell selection or reselection, the network signals the NES class indication as broadcast in the system information (SIB4/SIB5). Upon reception of the SIB1 indication for cell-specific SIB4/SIB5, the UE can decode the NES class indication and thus, the attainable QoS class identifier (QCI) associated with the respective NES class is configured and activated in the cell. Consequently, a cell is prioritized or down-prioritized for cell selection or reselection, as shown and described with reference to FIG. 2. The legacy (re) selection can serve as a baseline solution if an energy saving mode is not enabled. The UE performs this cell (re) selection in the NES mode using the proposed QoS-aware scheme if configured and enabled. When the cell is in an NES mode, a non-NES UE can access the cell only if the NES solution is backward compatible. It is configurable by the NES cell whether to bar non-NES UEs in the RRC idle mode. While the network allows NES-capable UEs to camp on the NES cell, it can configure these UEs to prioritize or deprioritize NES cells.

In a first implementation, camping restrictions for non-NES and NES-capable UEs are described. The NES class indication resolves the concern of barring UEs from NES cells and especially, barring NES-capable UEs from NES cells. If the NES class is set to zero, it implies that no NES feature is enabled in the cell, and any type of UE can access the cell. If the NES class >0, the non-NES UE is barred from the cell, and the specific NES class indication informs the UE about the NES features enabled and the respective supported QoS.

Aspects of the disclosure are described as enhancements for cell (re) selection, so as to enable a UE to perform cell (re) selection while considering the energy saving mode configured in the cell, the NES configuration supported in the cell, and the UE power saving features supported by the cell. Various parameters are included and described, including a remaining cell active time (also referred to as a remaining active time of a serving cell), which is the remaining time for which a cell will be in the active state (as determined by a UE). A DTX/DRX OFF duration is a period for which the cell will be in an inactive (sleep) state. A UE cell-active threshold is a predefined threshold for the active duration of the cell from the UE perspective, which is used to evaluate whether the remaining active time of the cell is sufficient for the UE to avoid radio link failure. A UE cell-sleep threshold is a predefined threshold for the non-active duration of the cell from the UE perspective, which is compared with the configured cell inactive (sleep) time.

In implementations, there may be one or more threshold(s) configured in the cell, which may be associated with one or more NES classes. A UE can select the threshold(s) from the system information block according to its device DTX/DRX cycle configuration. Using the NES class mechanism, which can provide the mapping of the NES class to a radio resource (NES) configuration, the cell (re) selection procedure is enhanced. There are different possible options to prioritize or down-prioritize the (re) selection of the cell.

FIG. 2 illustrates an example procedure 200 for prioritization or down-prioritization of a cell for an RRC idle UE, in accordance with aspects of the present disclosure. At 202 in the procedure, a determination is made as to whether a legacy cell NES class is greater than zero. If the NES class is set to zero, it implies that no NES feature is enabled in the cell, and any type of UE can access the cell. If the NES class=0, then no NES solution is applied and therefore at 204, the legacy or existing cell selection or reselection is performed. If NES class is greater than zero, then at 206, the legacy UE is barred from the cell, and the specific NES class indication informs the UE about the NES features enabled and the respective supported QoS. If the NES class >0, this implies that the NES solution is applied, and there are two possibilities, including (A), the UE is a legacy UE or a UE not supporting NES (non-NES UE), in which case the UE will be barred, meaning not allowed to connect to the cell; or (B), for all other UEs, this indicates that the UE is not a legacy or non-NES UE, but rather is an NES capable UE.

For NES capable UEs 208, a determination is made as to whether an NES technique is supported by the UE at 210. If “no”, then a non-NES UE is barred from the cell. If “yes”, then a determination is made as to whether a cell-sleep condition is met at 212. For an NES-capable UE, if the cell-sleep condition is met, then the UE prioritizes the cell for (re) selection at 214. Otherwise at 216, the cell (re) selection is down-prioritized.

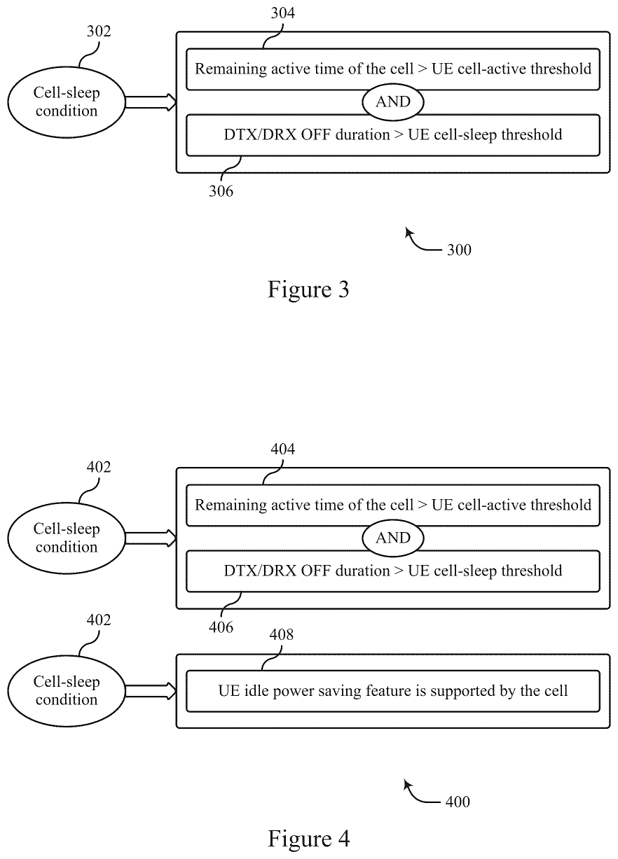

FIG. 3 illustrates an example 300 of cell-sleep conditions in accordance with aspects of the present disclosure. In a second implementation, the NES-capable UE may perform cell (re) selection evaluation based on the configured DTX/DRX sleep duration and on-duration, as illustrated in FIG. 2. For an NES-capable UE, if the configured NES technique is supported by the UE, the UE prioritizes the cell if a cell-sleep condition 302 (or one or more cell-sleep conditions) are met. In this example, the cell-sleep conditions are a remaining active time of the cell being greater than the UE cell-active threshold (at 304), and the DTX/DRX OFF duration is greater than the UE cell-sleep threshold (at 306). In an implementation, a UE may be informed about the DTX/DRX configuration using the NES class. Alternatively, in another implementation, the UE may receive the DTX/DRX confirmation with network capability information. The UE can determine the remaining active time of the cell using the DTX/DRX on-duration and the start offset. From the list of candidate cells, the UE filters the cells which meet the above conditions of the cell active duration and the cell OFF duration above the threshold. If more than one cell is found, the UE can select a cell with the strongest radio conditions to camp on.

FIG. 4 illustrates an example 400 of cell-sleep conditions in accordance with aspects of the present disclosure. In this example third implementation, the NES-capable UE may perform cell (re) selection evaluation based on the configured DTX/DRX sleep duration and on-duration as well as the supported UE power saving features. For an NES-capable UE, the UE can prioritize camping on a cell if the configured NES technique is supported by the UE and the UE power saving feature is supported by the cell. In this example, the cell-sleep conditions 402 are a remaining active time of the cell being greater than the UE cell-active threshold (at 404), the DTX/DRX OFF duration is greater than the UE cell-sleep threshold (at 406), and the UE idle power saving feature is supported by the cell (at 408). In an implementation, the UE may be informed about the DTX/DRX configuration using the NES class. Alternatively, in another implementation, the UE can receive the DTX/DRX configuration with network capability information signaled using SIBs. The UE can determine the remaining active time of the cell using the DTX/DRX on-duration and the start offset. The UE can receive the information supported UE power saving features as part of the network capability information.

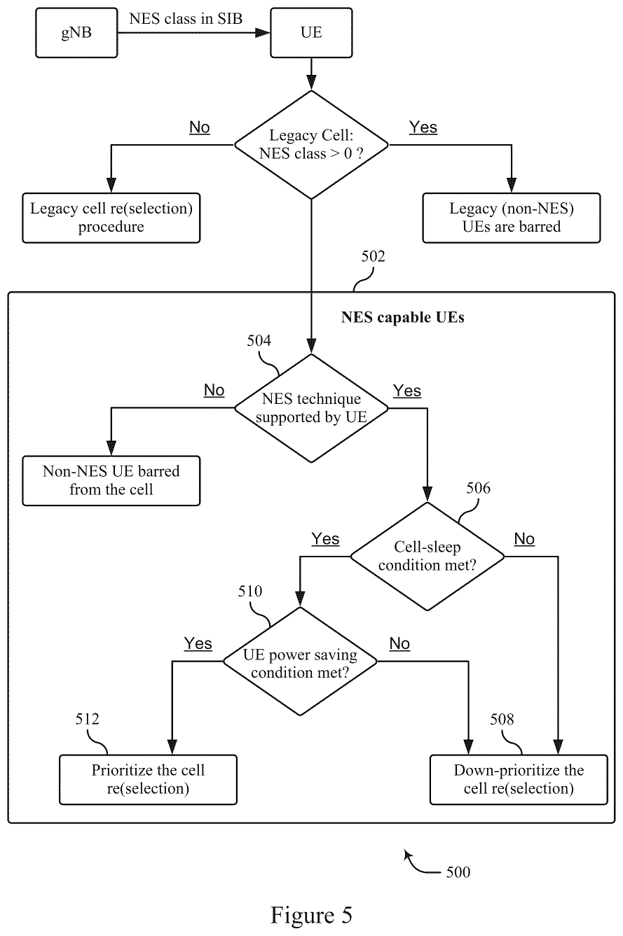

FIG. 5 illustrates another example procedure 500 for prioritization or down-prioritization of a cell for an RRC idle UE, in accordance with aspects of the present disclosure. In this example, for an NES capable UE 502, a determination is made as to whether an NES technique is supported by the UE at 504. If “no”, then a non-NES UE is barred from the cell. If “yes”, then a determination is made as to whether a cell-sleep condition is met at 506. If “no”, then the cell (re) selection is down-prioritized at 508. If “yes”, then at 510, a determination is made as to whether a UE power saving condition is met. For an NES-capable UE, if the cell-sleep condition is met (at 506), and if the UE power saving condition is met (at 510), then the UE prioritizes the cell for (re) selection at 512. Otherwise, then the cell (re) selection is down-prioritized at 508.

From the list of candidate cells, the UE filters the cells which meet the above cell-sleep conditions. Then the UE can connect to the cell that supports UE power saving features, such as low-power wake-up radio (LP-WUR), early paging indication, where the UE maximizes power saving and meets the UE power saving condition. If more than one cell is available, then the UE may connect to the cell with the strongest radio conditions. In an implementation, if the UE supports an idle mode power saving feature, such as LP-WUR, then the cell (re) selection procedure may restrict the UE to camp on the cell that supports its power saving feature, if available. In another implementation, when the UE power saving is not the priority, only the cell energy saving solution and corresponding conditions may be considered for cell (re) selection.

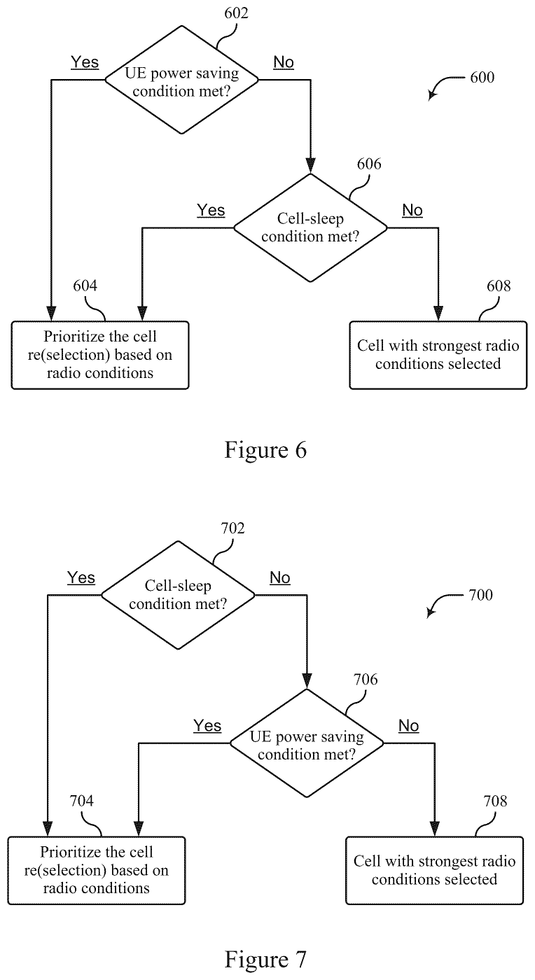

FIG. 6 illustrates an example 600 of cell selection prioritization, in accordance with aspects of the present disclosure. In this example, if the UE power saving is set to a higher priority than the cell-sleep condition, the UE filters all of the cells that support the UE idle power saving feature and camps on the cell with the strongest radio conditions. In the case that no cell is found in the UE power saving condition evaluation, the UE evaluates the list of the candidate cells for the cell-sleep condition (defined above) and camps on the cell with the strongest radio conditions. Otherwise, the UE selects the cell with the strongest radio conditions. For example, at 602, a determination is made as to whether a UE power saving condition is met. If “yes”, then at 604, the UE can prioritize the cell (re) selection based on radio conditions. If “no”, then at 606, a determination is made as to whether a cell-sleep condition is met. If “yes”, then again at 604, the UE can prioritize the cell (re) selection based on radio conditions. If “no”, then at 608, the UE can select the cell with the strongest radio conditions.

FIG. 7 illustrates another example 700 of cell selection prioritization, in accordance with aspects of the present disclosure. In this example, if the network energy saving criteria for user performance is set to a higher priority than the UE power saving, the UE filters all of the cells that fulfill the cell-sleep conditions and camps on the cell with the strongest radio conditions. In the case that no cell can be found in the cell-sleep condition evaluation, the UE evaluates the list of the candidate cells if the UE power saving features is supported by the cell and camps on the cell with the strongest radio conditions. Otherwise, the UE selects the cell with the strongest radio conditions. For example, at 702, a determination is made as to whether a cell-sleep condition is met. If “yes”, then at 704, the UE can prioritize the cell (re) selection based on radio conditions. If “no”, then at 706, a determination is made as to whether a UE power saving condition is met. If “yes”, then again at 704, the UE can prioritize the cell (re) selection based on radio conditions. If “no”, then at 708, the UE can select the cell with the strongest radio conditions.

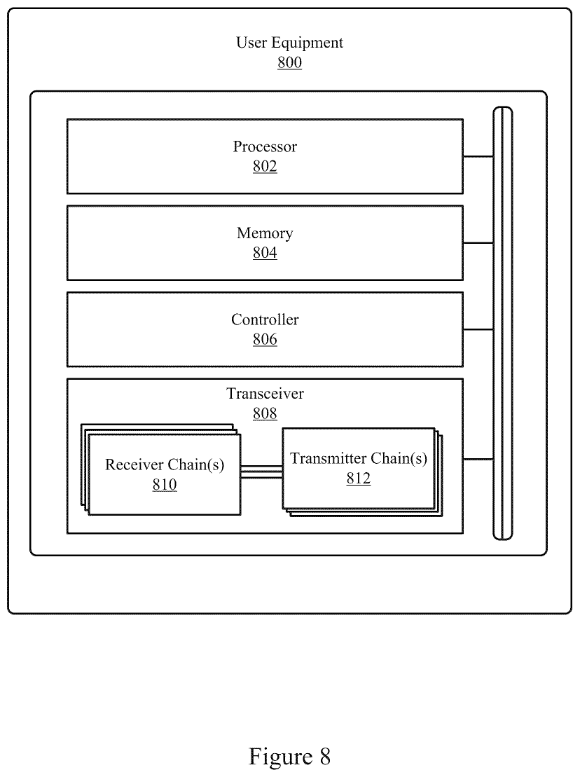

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving an indication of one or more of an NES configuration or an NES class; determining a remaining active time of a cell based at least in part on the NES configuration; and evaluating one or more cell-sleep conditions based at least in part on a UE cell-active threshold, a UE cell-sleep threshold, and a UE power saving state supported by the cell.

Additionally, the UE 800 may be configured to support any one or combination of the method further comprising determining whether the one or more cell-sleep conditions include the remaining active time of the cell is greater than the UE cell-active threshold; and an off-time period of the cell is greater than the UE cell-sleep threshold. The off-time period of the cell is a DTX/DRX off-time of the cell. The method further comprising prioritizing the cell for (re) selection if the one or more cell-sleep conditions are met. The method further comprising down-prioritizing the cell for (re) selection if the one or more cell-sleep conditions are not met. The further comprising receiving a DTX/DRX configuration from the cell; and determining the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The method further comprising performing cell (re) selection based at least in part on the NES configuration and the UE power saving state. The method further comprising prioritizing the cell for (re) selection based first on the UE power saving state and subsequently based on the one or more cell-sleep conditions. The method further comprising prioritizing the cell for (re) selection based first on the one or more cell-sleep conditions and subsequently based on the UE power saving state.

Additionally, or alternatively, the UE 800 may support at least one memory and at least one processor coupled with the at least one memory and configured to cause the UE to: receive an indication of one or more of an NES configuration or an NES class; determine a remaining active time of a cell based at least in part on the NES configuration; and evaluate one or more cell-sleep conditions based at least in part on a UE cell-active threshold, a UE cell-sleep threshold, and a UE power saving state supported by the cell.

Additionally, the UE 800 may be configured to support any one or combination of the at least one processor is configured to cause the UE to determine whether the one or more cell-sleep conditions include the remaining active time of the cell is greater than the UE cell-active threshold; and an off-time period of the cell is greater than the UE cell-sleep threshold. The off-time period of the cell is a DTX/DRX off-time of the cell. The at least one processor is configured to cause the UE to prioritize the cell for (re) selection if the one or more cell-sleep conditions are met. The at least one processor is configured to cause the UE to down-prioritize the cell for (re) selection if the one or more cell-sleep conditions are not met. The at least one processor is configured to cause the UE to receive a DTX/DRX configuration from the cell; and determine the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The at least one processor is configured to cause the UE to perform cell (re) selection based at least in part on the NES configuration and the UE power saving state. The at least one processor is configured to cause the UE to prioritize the cell for (re) selection based first on the UE power saving state and subsequently based on the one or more cell-sleep conditions. The at least one processor is configured to cause the UE to prioritize the cell for (re) selection based first on the one or more cell-sleep conditions and subsequently based on the UE power saving state.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

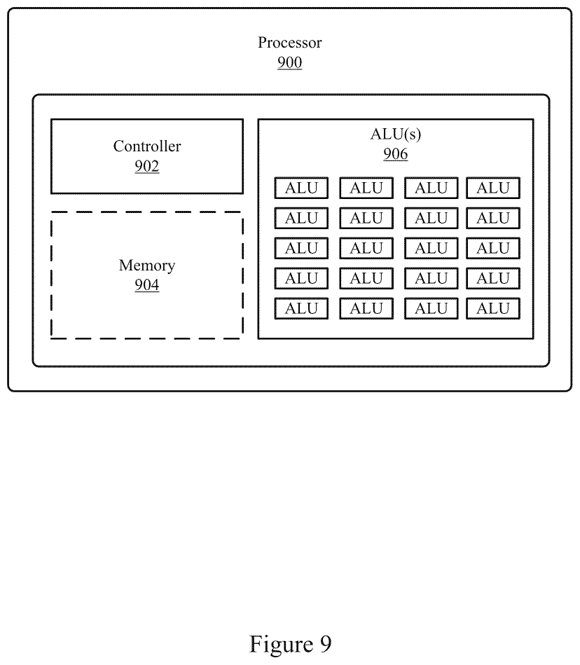

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller coupled with at least one memory and configured to cause the processor to: receive an indication of one or more of an NES configuration or an NES class; determine a remaining active time of a cell based at least in part on the NES configuration; and evaluate one or more cell-sleep conditions based at least in part on a UE cell-active threshold, a UE cell-sleep threshold, and a UE power saving state supported by the cell.

Additionally, the processor 900 may be configured to or operable to support any one or combination of the at least one controller is configured to cause the processor to determine whether the one or more cell-sleep conditions include the remaining active time of the cell is greater than the UE cell-active threshold; and an off-time period of the cell is greater than the UE cell-sleep threshold. The off-time period of the cell is a DTX/DRX off-time of the cell. The at least one controller is configured to cause the processor to prioritize the cell for (re) selection if the one or more cell-sleep conditions are met. The at least one controller is configured to cause the processor to down-prioritize the cell for (re) selection if the one or more cell-sleep conditions are not met. The at least one controller is configured to cause the processor to receive a DTX/DRX configuration from the cell; and determine the remaining active time of the cell as a function of an on-duration of the cell, a start slot of the DTX/DRX configuration, and an offset of the DTX/DRX configuration. The off-time period of the cell is derived from the on-duration of the cell and a periodicity of the DTX/DRX configuration. The at least one controller is configured to cause the processor to perform cell (re) selection based at least in part on the NES configuration and the UE power saving state. The at least one controller is configured to cause the processor to prioritize the cell for (re) selection based first on the UE power saving state and subsequently based on the one or more cell-sleep conditions. The at least one controller is configured to cause the processor to prioritize the cell for (re) selection based first on the one or more cell-sleep conditions and subsequently based on the UE power saving state.

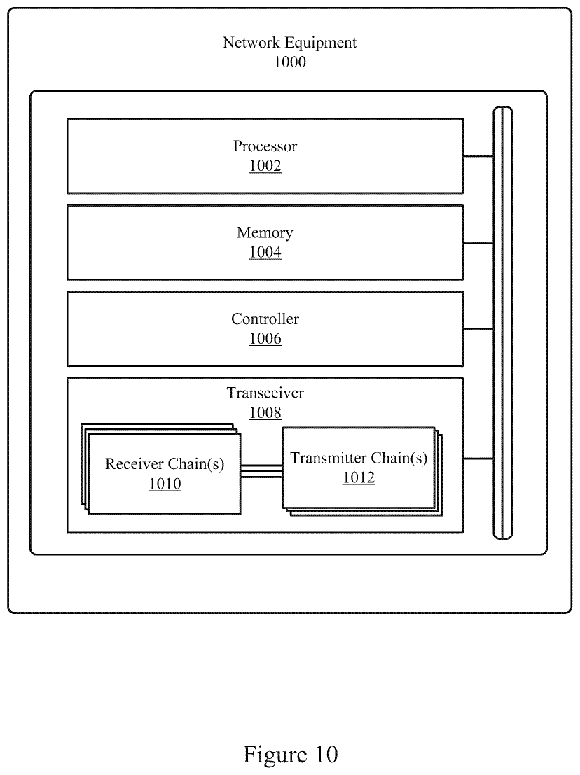

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for establishing an energy savings priority based on at least network energy savings and UE energy savings; and transmitting an NES configuration that is mapped to an NES class to a UE from which the UE establishes a (re) selection priority based at least in part on the network energy savings and the UE energy saving.

Additionally, the NE 1000 may be configured to or operable to support any one or combination of the NES configuration indicates the (re) selection priority based first on the UE energy savings and subsequently based on the network energy savings. The NES configuration indicates the (re) selection priority based first on the network energy savings and subsequently based on the UE energy savings.

Additionally, or alternatively, the NE 1000 may support at least one memory and at least one processor coupled with the at least one memory and configured to cause the NE to: establish an energy savings priority based on at least network energy savings and UE energy savings; and transmit an NES configuration that is mapped to an NES class to a UE from which the UE establishes a (re) selection priority based at least in part on the network energy savings and the UE energy saving.

Additionally, the NE 1000 may be configured to support any one or combination of the NES configuration indicates the (re) selection priority based first on the UE energy savings and subsequently based on the network energy savings. The NES configuration indicates the (re) selection priority based first on the network energy savings and subsequently based on the UE energy savings.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

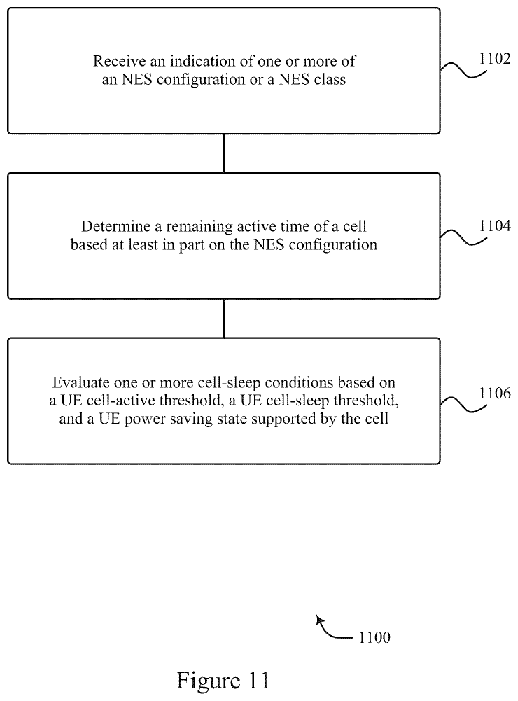

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving an indication of one or more of an NES configuration or an NES class. The operations of 1102 may be performed in accordance with examples as described herein. In some implementations, aspects of the operations of 1102 may be performed by a UE as described with reference to FIG. 8.

At 1104, the method may include determining a remaining active time of a cell based at least in part on the NES configuration. The operations of 1104 may be performed in accordance with examples as described herein. In some implementations, aspects of the operations of 1104 may be performed by a UE as described with reference to FIG. 8.

At 1106, the method may include evaluating one or more cell-sleep conditions based at least in part on a UE cell-active threshold, a UE cell-sleep threshold, and a UE power saving state supported by the cell. The operations of 1106 may be performed in accordance with examples as described herein. In some implementations, aspects of the operations of 1106 may be performed a UE as described with reference to FIG. 8.

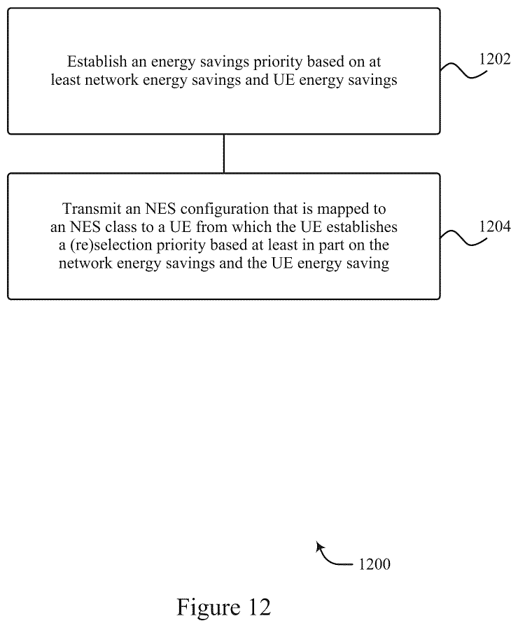

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include establishing an energy savings priority based on at least network energy savings and UE energy savings. The operations of 1202 may be performed in accordance with examples as described herein. In some implementations, aspects of the operations of 1202 may be performed by a NE as described with reference to FIG. 10.

At 1204, the method may include transmitting an NES configuration that is mapped to an NES class to a UE from which the UE establishes a (re) selection priority based at least in part on the network energy savings and the UE energy saving. The operations of 1204 may be performed in accordance with examples as described herein. In some implementations, aspects of the operations of 1204 may be performed by a NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive an indication of one or more of a network energy saving (NES) configuration or an NES class;
determine a remaining active time of a cell based at least in part on the NES configuration; and
evaluate one or more cell-sleep conditions based at least in part on a UE cell-active threshold, a UE cell-sleep threshold, and a UE power saving state supported by the cell.

2. The UE of claim 1, wherein the at least one processor is configured to cause the UE to determine whether the one or more cell-sleep conditions include:
the remaining active time of the cell is greater than the UE cell-active threshold; and
an off-time period of the cell is greater than the UE cell-sleep threshold.

3. The UE of claim 2, wherein the off-time period of the cell is a discontinuous transmission and discontinuous reception (DTX/DRX) off-time of the cell.

4. The UE of claim 2, wherein the at least one processor is configured to cause the UE to one of prioritize the cell for (re) selection if the one or more cell-sleep conditions are met, or down-prioritize the cell for the (re) selection if the one or more cell-sleep conditions are not met.

5. The UE of claim 2, wherein the at least one processor is configured to cause the UE to:
receive a discontinuous transmission and discontinuous reception (DTX/DRX) configuration from the cell; and
determine the remaining active time of the cell as a function of an on-duration of the cell, a start slot of the DTX/DRX configuration, and an offset of the DTX/DRX configuration.

6. The UE of claim 5, wherein the off-time period of the cell is derived from the on-duration of the cell and a periodicity of the DTX/DRX configuration.

7. The UE of claim 1, wherein the at least one processor is configured to cause the UE to perform cell (re) selection based at least in part on the NES configuration and the UE power saving state.

8. The UE of claim 1, wherein the at least one processor is configured to cause the UE to prioritize the cell for (re) selection based first on the UE power saving state and subsequently based on the one or more cell-sleep conditions.

9. The UE of claim 1, wherein the at least one processor is configured to cause the UE to prioritize the cell for (re) selection based first on the one or more cell-sleep conditions and subsequently based on the UE power saving state.

10. A processor for wireless communication, comprising:
at least one controller coupled with at least one memory and configured to cause the processor to:
receive an indication of one or more of a network energy saving (NES) configuration or an NES class;
determine a remaining active time of the cell based at least in part on the NES configuration; and
evaluate one or more cell-sleep conditions based at least in part on a user equipment (UE) cell-active threshold, a UE cell-sleep threshold, and a UE power saving state supported by the cell.

11. The processor of claim 10, wherein the at least one controller is configured to cause the processor to determine whether the one or more cell-sleep conditions include:
the remaining active time of the cell is greater than the UE cell-active threshold; and
an off-time period of the cell is greater than the UE cell-sleep threshold.

12. The processor of claim 11, wherein the off-time period of the cell is a discontinuous transmission and discontinuous reception (DTX/DRX) off-time of the cell.

13. The processor of claim 11, wherein the at least one controller is configured to cause the processor to one of prioritize the cell for (re) selection if the one or more cell-sleep conditions are met, or down-prioritize the cell for the (re) selection if the one or more cell-sleep conditions are not met.

14. The processor of claim 11, wherein the at least one controller is configured to cause the processor to:
receive a discontinuous transmission and discontinuous reception (DTX/DRX) configuration from the cell; and
determine the remaining active time of the cell as a function of an on-duration of the cell, a start slot of the DTX/DRX configuration, and an offset of the DTX/DRX configuration.

15. The processor of claim 14, wherein the off-time period of the cell is derived from the on-duration of the cell and a periodicity of the DTX/DRX configuration.

16. The processor of claim 10, wherein the at least one controller is configured to cause the processor to perform cell (re) selection based at least in part on the NES configuration and the UE power saving state.

17. The processor of claim 10, wherein the at least one controller is configured to cause the processor to prioritize the cell for (re) selection based first on the UE power saving state and subsequently based on the one or more cell-sleep conditions.

18. The processor of claim 10, wherein the at least one controller is configured to cause the processor to prioritize the cell for (re) selection based first on the one or more cell-sleep conditions and subsequently based on the UE power saving state.

19. A method performed by a user equipment (UE), the method comprising:
receiving an indication of one or more of a network energy saving (NES) configuration or an NES class;
determining a remaining active time of a cell based at least in part on the NES configuration; and
evaluating one or more cell-sleep conditions based at least in part on a UE cell-active threshold, a UE cell-sleep threshold, and a UE power saving state supported by the cell.

20. A network equipment (NE) for wireless communication, comprising:
at least one memory; and
at least one processor coupled with the at least one memory and configured to cause the NE to:
establish an energy savings priority based on at least network energy savings and user equipment (UE) energy savings; and
transmit a network energy saving (NES) configuration that is mapped to an NES class to a UE from which the UE establishes a (re) selection priority based at least in part on the network energy savings and the UE energy saving.
